(19) United States
(12) Patent Application Publication
(10) Pub. No.: US 2007/0026375 A1
(43) Pub. Date: Feb. 1, 2007

(54) Electronic study aid and practice aid

(76) Inventor: Russell H. Dewey, Los Altos, CA (US)

Correspondence Address: Russell H. Dewey, PMB #223, 101 First Street, Los Altos, CA, 94022, US

(21) Appl. No.: 11/194,715

(22) Filed: Aug. 1, 2005

(51) Int. Cl. G09B 3/00

(52) U.S. Cl. 434/350; 434/362

(57) ABSTRACT

An apparatus and methods are disclosed that provide a self-help electronic study aid and practice aid for academic subjects. Key components include: an integrated electronic student desktop (30), an interactive web page based electronic student workbook (40), a template-driven method for on-demand generation and display of an electronic student workbook web page (28), an integrated multi-lingual multi-media dictionary reference(68), an integrated electronic grammar reference (66), an integrated library of grade-level specific electronic books and stories (70), an integrated library of educational games and puzzles (80), a multi-media avatar window (44) for continuous feedback to the student user; and a server-side data storage and retrieval means (22) that provides consistent and fresh data to all of the system components.

### CROSS-REFERENCE TO RELATED APPLICATIONS

Not Applicable

### STATEMENT REGARDING FEDERALLY SPONSORED RESEARCH OR DEVELOPMENT

Not Applicable

### MATERIAL SUBMITTED SEPARATELY ON COMPACT DISK

Not Applicable

### BACKGROUND OF THE INVENTION

1. Field of the Invention

The currently disclosed invention relates generally to education, and particularly to that class of computer-assisted devices for presenting information and questions, soliciting responses, and providing continuous feedback to the user.

2. The Need for Study Aids and Practice Aids

Not all students learn at the same rate or in the same way. Within almost all academic situations, even with the best of teachers and tutors and materials and methods, some students will advance according to expectations, but others will want to advance more rapidly and still others will begin to fall behind. Study aids and practice aids exist to help the faster learner to advance more quickly. Study aids and practice aids exist to help the slower learner to keep up with the class.

3. Discussion of Prior Art—Non-Computer Based Study Aids and Practice Aids

Paper-based workbooks and CD-ROM courses are widely available as study aids and practice aids. However, they have limited or no interactive intelligence. They cannot remember and recall student work. They are not comprehensive, typically lacking collateral reference materials and practice materials. They cannot be easily modified and updated without the publisher going through an expensive and time-consuming re-authoring, manufacturing, and re-distribution business cycle.

4. Discussion of Prior Art—Computer Based Study Aids and Practice Aids

U.S. Pat. No. 6,793,129 by Wood, et al. (2004) discloses an electronic portable study aid apparatus with the ability to download instructional materials from a server. However, the Wood patent is not a complete and comprehensive study aid and practice aid, since it is missing coordinated collateral reference materials. The Wood patent makes no provision for retained data storage of student inputs and makes no provision for the automated generation and assembly of the downloadable materials.

U.S. Pat. No. 6,146,148 by Stuppy (2000) discloses a method for generating and delivering an electronic student workbook. The present invention is an improvement on the Stuppy patent. The electronic student workbook disclosed in the Stuppy patent is structured as a teaching aid and contains lesson teaching material and testing exercises for a student to perform. A teacher oversees the delivery of teaching material and oversees student responses to testing exercises. The present invention is an improvement because it is structured as a self-help study aid and practice aid and contains self-help lesson review material and practice exercises for a student to perform without the aid of a teacher or tutor. A programmatic method oversees the delivery of study material and oversees student responses to practice exercises.

The electronic student workbook disclosed in the Stuppy patent is generated by selecting materials from a library of pre-authored teaching lesson materials and testing exercise materials, according to a profile of student skill gaps. The electronic workbook in the present invention is an improvement because it is generated programmatically from standardized web page templates and obtains its content from a relational database of reusable web page components comprising multi-media study materials and practice exercises suitable for all students.

The electronic student workbook disclosed in the Stuppy patent is delivered through a system comprising a student computer and a teacher computer and a networking session between the student computer and the teacher computer for the exchange of information. The electronic workbook in the present invention is an improvement because it is delivered through a system comprising a student computer only. The electronic workbook in the present invention is a further improvement because it is generated on demand, one page at a time, and delivered through an integrated electronic student desktop that contains everything a student needs for independent, self-service study and practice. No such electronic desktop is disclosed in the Stuppy patent.

The present invention is a further improvement because it integrates the content and use of electronic student workbook pages with the content and use of various online collateral study-aid and practice-aid reference materials which all draw their content from a common database—to assure that such contents are always fresh and always consistent.

U.S. Pat. Nos. 6,592,379 and 6,666,687 and 6,733,295 and 6,749,434 by Stuppy disclose continued improvements in the basic design first disclosed in the '148 patent. They do not, however, depart from the core principle of a teacher-student interaction and workbook containing teaching and testing materials based on a student skill profile. The present disclosed invention does not require or include a teacher. The present invention delivers standardized and graduated self-study and practice materials, not skill-gap specific teaching and testing materials.

U.S. Pat. No. 6,898,411 by Ziv-el, et al. discloses a method and system for online teaching using teachers, teacher computers, student computers, and web page based electronic workbooks in which web pages are retrieved according to their uniform resource locators (URL). The present invention is an improvement because the web pages in the present invention are generated on-demand and are not pre-stored and retrieved according to static URLs.

### BRIEF SUMMARY OF THE INVENTION

In accordance with the present invention an apparatus and methods are disclosed that in combination provide an electronic study aid and practice aid for independent learners of academic subjects. The present invention has the following objects and advantages:

(a) Self-service features and functions, eliminating the need and cost for teachers, classrooms, transportation, paper-based reference materials, teacher workbooks, and teacher computers;

(b) Study and practice features and functions that are interactive and constructive, with a means for programmatically understanding user inputs, retaining those inputs in a persistent data store, and responding programmatically in real-time to those inputs;

(c) A comprehensive and fully integrated study and practice environment including not only web page based study and practice materials, but coordinated online reference materials as well, all drawing their content from a common data store;

(d) Automated study aid and practice aid content management whereby workbook pages are generated on-demand from executable program scripts that will retrieve their content objects from a common data store.

Further objects and advantages of my invention will become apparent from a consideration of the drawings and ensuing description.

### BRIEF DESCRIPTION OF THE SEVERAL VIEWS OF THE DRAWING

FIG. 1 is a block diagram depicting major method, data, and output components of one embodiment of the present invention.

FIG. 2 depicts a preferred client/server apparatus for the present invention.

FIG. 3 depicts the preferred hierarchical structure of a workbook web page template.

FIG. 4 depicts details of data components of one embodiment of the present invention.

### DETAILED DESCRIPTION OF THE INVENTION

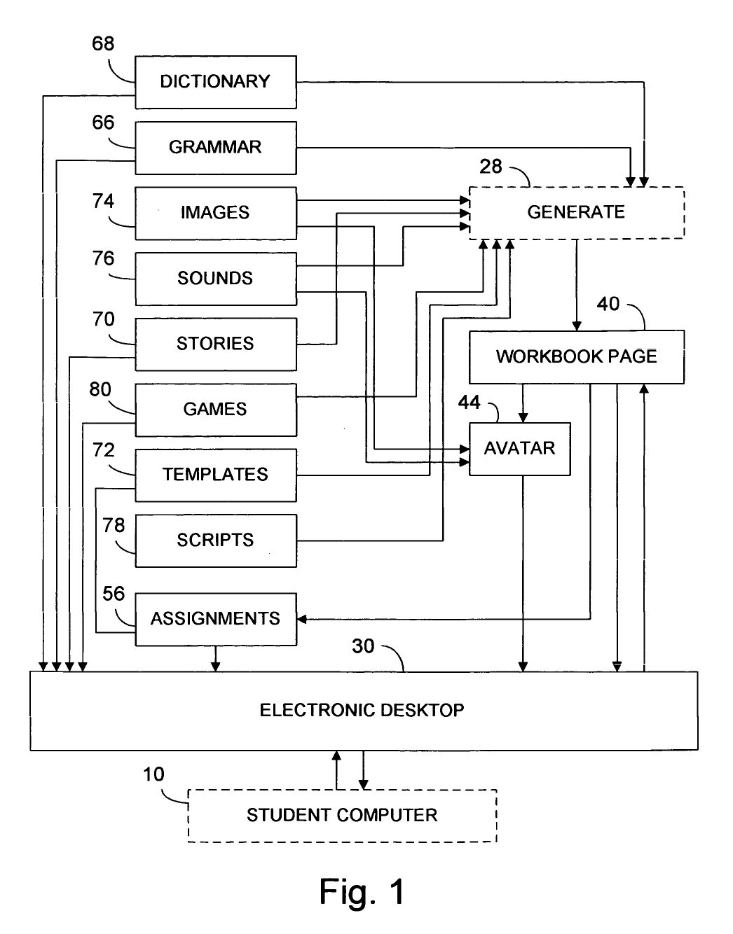

FIG. 1

FIG. 1 is a block diagram depicting major method, data, and output components of one embodiment of the present invention. The embodiment depicted in FIG. 1 is an actual commercial implementation of the present invention that specifically delivers a web page based study aid and a practice aid for students learning the English language. Alternate embodiments are anticipated.

Data components are stored in a server-side data storage and retrieval means of a type widely known in the art. The data storage and retrieval means in the depicted embodiment includes a multi-media bi-lingual dictionary (68), a glossary of English language grammar terms and their definitions (66), a library of graphical images (74), a library of playable sounds (76), a library of electronic books and stories for reading practice (70), a library of educational games and puzzles for reinforcement of subject matter(80), a library of reusable workbook web page templates (72), a library of client-side scripts for web page interactivity(78), and a record of current and completed study and practice assignments (56) with each record cross-referenced to its corresponding web page template (72).

A server-side script processing method (28) of a type widely known in the art is a method that assembles components contained in or referenced by the pre-authored workbook web page templates (72), which templates must be in the form of server-side scripts that are coded in a prescribed scripting language format and grammar. From the assembled components, the server-side script processing method (28) generates a workbook web page (40) with embedded intelligence and interactivity functions according to the desires of the web page author.

A method of the present invention displays a generated interactive electronic student workbook web page (40) in an integrated electronic student desktop (30) on a client-side student computer (10). The electronic student desktop is comprised of a web page frameset which contains a plurality of windows and their content.

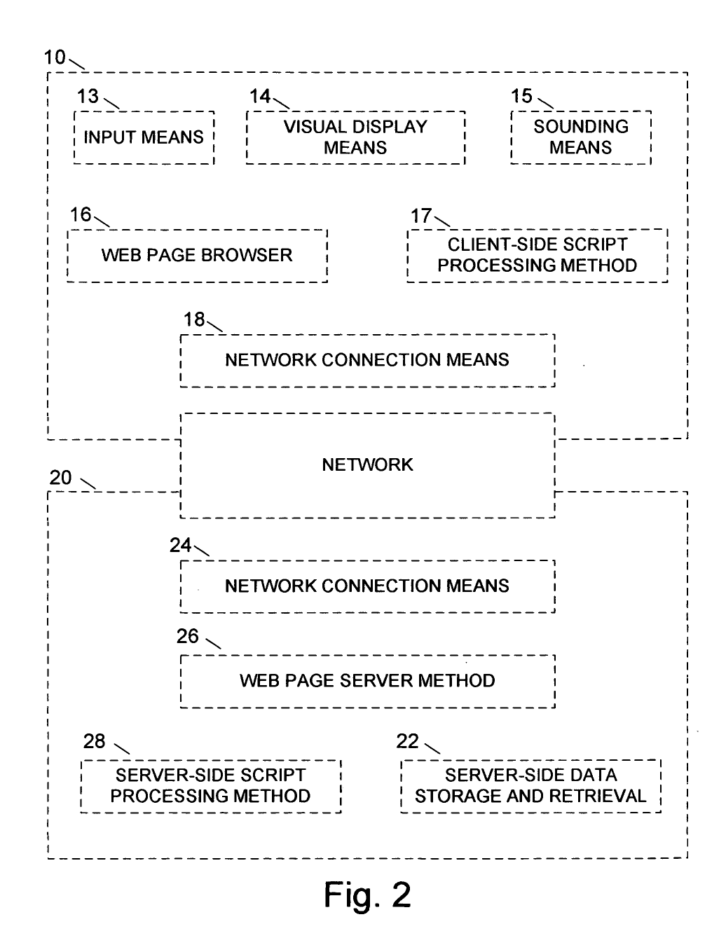

FIG. 2

FIG. 2 depicts a preferred client/server apparatus for the present invention. A client-side student computer (10), of a type widely known in the art, is comprised of a memory and a stored instruction processing unit, and a web page browser (16), an input device selected from the group consisting of keyboards and handwriting recognition devices, a pointing device, a graphical visual display means (14), an output sounding means (15) selected from the group consisting of speakers and headphones, and a client-side network connection means (18) for communicating with other computer systems connected to a network.

A server-side computer system (20), of a type widely known in the art, is comprised of a memory and a stored instruction processor, and a server-side data storage and retrieval means (22), a server-side network connection means (24) for communicating with other computer systems connected to a network, a web page server method (26) that listens to the network and responds to requests that come in the form of Uniform Resource Locators (URLs) and which web server method retrieves web pages from the data storage and retrieval means (22) and directs them to the network connection means (24), and a server-side script processing method (28) that interprets and executes programmatic instructions encoded in certain files stored in the data storage and retrieval means (22) and generates web pages formatted with Hypertext Markup Language (HTML) for the web page server method (26), which web pages also contain embedded client-side scripts for execution in the client-side student computer (10) when the web page is delivered.

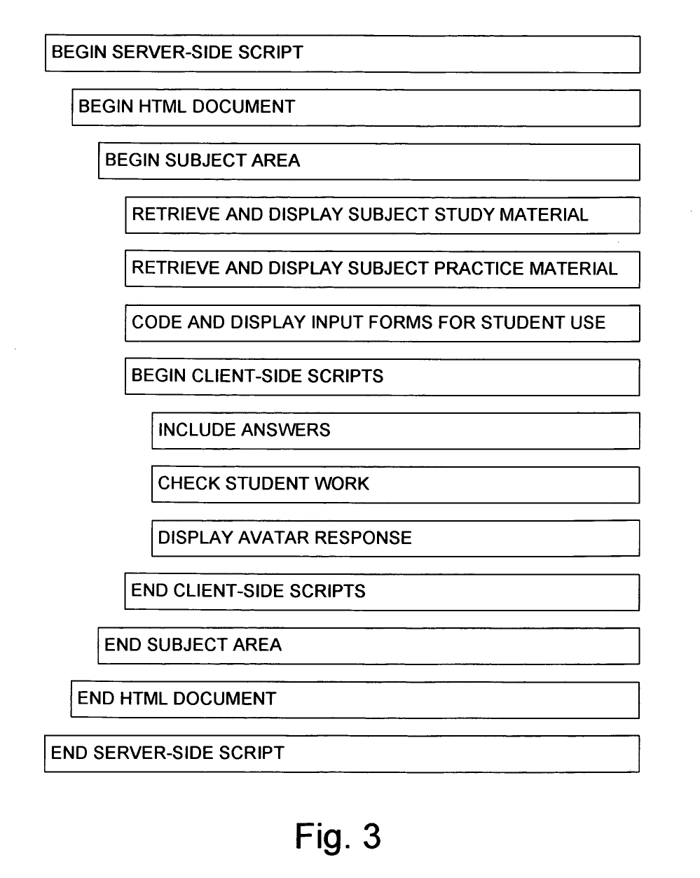

FIG. 3

FIG. 3 depicts the preferred hierarchical structure of a workbook web page template. Each workbook page template (72) begins with a statement to start a server-side script. Each workbook page template ends with a statement to end a server-side script. Between the start server-side script statement and the end server-side script statement, are placed a pair of HTML tags to begin a web page and end a web page.

Between the beginning and ending HTML web page document tags are one or more blocks of server-side script code, one for each subject area. In the commercial implementation of the present invention depicted in FIG. 1, the subject areas are: phonics, grammar, vocabulary, spelling, reading comprehension, and writing.

The detailed content of all such server-side scripting code and client-side scripting code will depend on the particular server-side and client-side scripting languages used for implementation. The detailed content of all such server-side scripting code and client-side scripting code is omitted from this specification, for the sake of brevity, but will be obvious from the specification to anyone skilled in the art of computer programming.

Each subject area block of server-side script code begins with an HTML header tag. Each subject area block of server-side script code is organized into the following sub-blocks of server-side script code:

(d) Retrieve and Display Subject Study Materials—text, graphics and sound files for student study within a subject area are retrieved from the server-side data storage and retrieval means (22) and formatted for display;

(e) Retrieve and Display Subject Practice Materials—text, graphics and sound files for student practice within a subject area are retrieved from the server-side data storage and retrieval means (22) and formatted for display;

(f) Code and Display Input Forms for Student Use—text and graphic input boxes and lists of selectable choices are coded as named HTML elements;

(g) Client-Side Scripts—scripts within a subject area that are intended to be executed on the student computer are included between a start client-side script tag and an end client-side script tag and include the following;

(h) Include Answers—answer arrays containing answers to questions,

(i) Check student work—functions, or methods, for checking a students work, by comparing a students input with a correct answer in an answer array, and for displaying a correct answer from an answer array in the named field of the named input form used by the student.

(j) Display Avatar Response—a function that, when called by another client-side script function, will programmatically determine whether the students answer was correct or not and then programmatically generate a multi-media avatar response, with text, images, and sounds in a pop-up window,

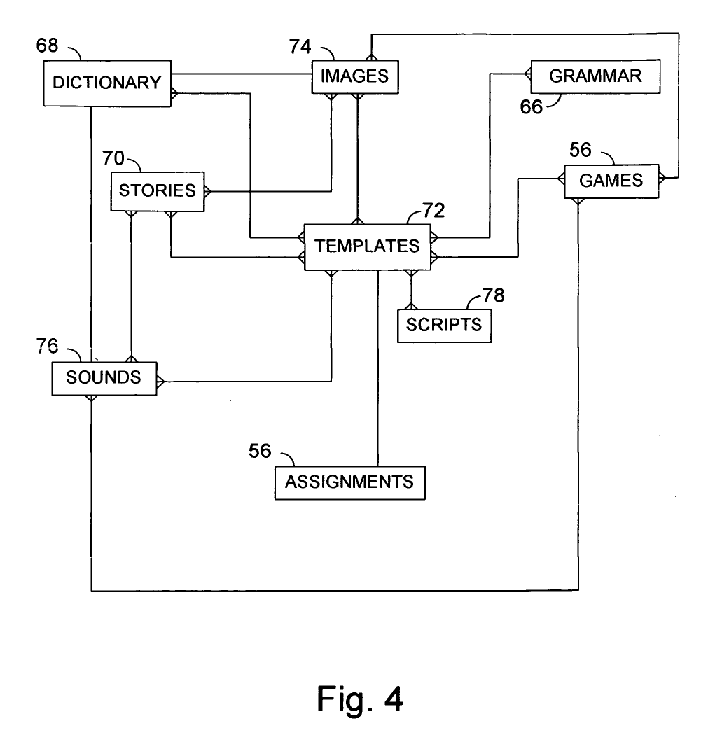

FIG. 4

FIG. 4 depicts details of the data tables and files comprising the embodiment of the present invention depicted in FIG. 1.

Assignments Table (56)

Each entry in the students table will have associated with it one or more records in an assignments table. Each such record in the assignments table contains a pointer to a specific workbook template in a lessons table (72) for a unit of lessons assigned to a specific student. A student may have one such assignments record if the student is working on their first assignment. The student will have multiple records in the assignments table if the student has completed at least one such assignment. One record in the assignments table will always be designated as the current assignment. The other records will be designated as completed assignments.

Grammar Table (66)

A grammar table contains one or more records, with one record for each defined term of language grammar. Each record in the grammar table contains the grammar term to be defined, and examples of correct usage. Each record in the grammar table may also contain one or more hyperlinks to other related grammar terms. Students have direct access to the grammar through their electronic desktop. Workbook web page templates in the lessons table (72) have access to the grammar through a programmatic SQL retrieve.

Dictionary Table (68)

A dictionary table contains one or more records, with one or more records for each defined word in the dictionary. Each record in the dictionary table contains the language word to be defined, a definition number if there are multiple definitions for the same word, the part of speech, the definition, an example of correct usage, a reference to a graphic image file for the purpose of producing an illustrated, a reference to a sound file representing the defined word as spoken, and none or one or more equivalent words or characters representing the defined word translated into none or one or more other languages. Students have direct access to the dictionary table through their electronic desktop. Workbook web page templates in the lessons table (72) have access to the dictionary through a programmatic SQL retrieve.

Stories Table (70)

A stories table contains a text record for each story contained in the stories table. Each story in the stories table may contain none or one or more references to graphic files stored in an images file directory. Stories in the stories table may be incorporated by reference into workbook page templates stored in the templates file directory. Stories may also contain references to sound files. Students have direct access to stories through their electronic desktop.

Templates (72)

A plurality of templates are stored in a templates file directory, one for one each page of an interactive multi-media electronic student workbook. In the one embodiment of the present invention depicted in FIG. 1, each lesson template file is a text file stored on a server-side computer system. Each record in the lesson template file directory is a combination of native HTML code, cascading style sheet (CCS) code, embedded client-side JavaScript, and embedded server-side PHP script. Alternate scripting languages are anticipated.

Each such file in the templates directory contains one or more references to external graphic files stored in an images file directory and external sound files stored in a sounds file directory. Each file in the templates file directory may also contain one or more references to stories in the stories table, and definitions of words in the dictionary table, and grammar terms in the glossary table.

Each template, with embedded scripts and external references, must be coded and stored in the format described herein, such that they may be assembled programmatically into web pages by the server-side script processing method (28).

Images File Directory (74)

An images file directory contains a binary encoded record for each digital image contained in the images file directory. Such images are incorporated by HTML reference into lesson units, stories, and the dictionary.

Sounds File Directory (76)

A sounds file directory contains a binary encoded record for each digital sound contained in the sounds file directory. Such sounds are incorporated by HTML or JavaScript object reference into workbook lesson units, stories, the online dictionary, and each programmatically generated avatar window. Such sounds are played back through the client-side computer system.

Scripts Library (78)

A scripts library file directory contains reusable client-side scripts, which may be retrieved by the server-side script processing method (28) and thereby included in workbook web pages.

Games Library (80)

A games file directory contains a link to each game available to the student. Each game may contain none or one or more references to graphic files stored in an images file directory. Games may be incorporated by reference into workbook page templates stored in the templates file directory. Games may also contain references to sound files. Students also have direct access to games through their electronic desktop.

### Description—Administrative Application Software Methods

Administrative application software methods that are typical in commercial web-based membership-based applications, including such methods as enrollment, registration, login, logout, session management, and payment processing will be obvious to anyone skilled in the art of computer programming, and are omitted herein for the sake of brevity.

### Description—Student Operation

Reference is made again to the embodiment depicted in FIG. 1, which is a commercial implementation of the present invention that delivers a web page based study aid and a practice aid for independent learners of the English language. Alternate embodiments are anticipated.

Referring to FIG. 1, an enrolled student first logs in to a general administrative web application login method. A method in the present invention recognizes the individual student from the login name and creates an electronic desktop customized and personalized for that specific student. From that student desktop, the student may click on and choose from a variety of menu items.

The student may click on an electronic dictionary menu item to look up a word in the electronic dictionary (68). The student may type in the word to be looked up using a keyboard, or the student my select the desired word from on-screen text by using a pointing and selecting device. The invention will retrieve and display the desired word and its definition, an example of correct usage, the correct part of speech, an illustration of the word when such an illustration exists in the data storage and retrieval means, and a translation of the word into another language when such a translation exists in the data storage and retrieval means.

The student may click on an electronic glossary of grammar terms menu item to look up a term in the electronic grammar (66). The student may type in the term to be looked up using a keyboard, or the student my select the desired term from on-screen text by using a pointing and selecting device. The invention will retrieve and display the desired term and its definition, and an example of correct usage from the data storage and retrieval means.

The student may click on an electronic book and electronic stories menu item to display a list of available electronic books and stories (70) suitable for the students current grade level.

The student may click on an educational-games and educational-puzzles menu item to display a list of available electronic games and puzzles (80) suitable for the students current grade level. In the preferred embodiment of the present invention, such educational games and puzzles are authored in such a way as to correlate with lesson content in the electronic student workbook pages (40). For example, a crossword puzzle may be authored and stored in the games table of the present invention where such a crossword puzzle is designed specifically to use the same words that are used in a workbook vocabulary lesson, and where such words are defined in the electronic dictionary of the present invention.

The student may click on an assignments menu item to view a list of links to the current and all completed workbook assignments. The student may click on the current assignment link to cause a method of the present invention to look up the corresponding web page template identification number and to pass that web page template identification number to a server-side script processing method (28) which will generate a web page and send it to a client-side browser for display on the student electronic desktop on the student computer.

The student may interact directly with a study aid and practice aid workbook web page as follows. The student may click on buttons and links in the displayed workbook web page to invoke executable embedded scripts containing pre-authored intelligence. Those scripts will create and display dynamic text, images, and sounds in response to the student's actions. The student may enter data into text boxes or select text or images from arrays of text and image choices.

In response to student's actions, a method of the present invention, using scripts embedded in the workbook web page, creates and displays a temporary multi-media avatar. The avatar will contain specific in situ communication for the student.

Each study aid and practice aid workbook web page also has an indicia on it which, when clicked, will be passed to a method of the present invention to mark the current assignment in the assignments table as complete, and create a new assignment in the assignments table. The new assignment will be linked to the next web page template in a predetermined sequence. Each workbook web page template in the data storage and retrieval means is calibrated to a specific skill level, from beginner to advanced.

The student may click on a link in a list of completed assignments in order to generate and display that assignments associated web page, so that the student may review the lesson content and exercises again, whenever he or she wishes.

### Description and Operation—Alternative Embodiments

Many alternative embodiments are possible while maintaining the overall objects and advantages of the presently disclosed invention, including these alternative embodiments:

(a) the client-side computer system and the server-side computer system may be combined and implemented in a single computer without an inter-computer network connection;

(b) where there are two separate computers, the communications between the computers may be accomplished by a private network means or a public network means;

(c) the student self-study and practice computer may be situated anywhere: in a kiosk or other dedicated area within a school classroom or school library, or possibly situated within a public library;

(d) where the present invention stores some data in database tables and some data in flat files, an alternative embodiment may store all data in database tables, or store all data in flat files;

(e) in addition to providing a language student with a study aid and practice aid for reading and writing, the present interactive electronic workbooks could easily be expanded to include study material and practice material for speaking and listening skills; and, (f) the present invention could easily be adapted and used to provide self-service study aid and practice aid activities and content for other academic subjects, such as mathematics.

Although the description above contains much specificity, the description should not be construed as limiting the scope of the invention but as merely providing illustrations of some of the presently preferred embodiment and alternative embodiments of this invention. Thus the scope of the invention should be determined by the appended claims and their legal equivalents, rather than by the examples given.

I claim:

1. A study aid and practice aid apparatus, comprising:
(a) a plurality of client-side student computers, each of which includes a memory and a stored program instruction processing unit and:
(i) an input means selected from the group consisting of keyboards and handwriting recognition devices and pointing devices,
(ii) a graphical visual display means, and
(iii) an output sounding means selected from the group consisting of speakers and headphones, and
(iv) a web page browser browser,
(v) a client-side script processing method, and
(vi) a client-side network connection means, and
(b) at least one server-side web application and database computer, which includes a memory and a stored instruction processor, and:
(i) a server-side network connection means,
(ii) a web page server method,
(iii) a server-side script processing method,
(iii) a server-side data storage and retrieval means, and
(c) a network for client/server computer communication.

2. The study aid and practice aid apparatus of claim 1, wherein the said data storage and retrieval means includes a student assignments table containing a plurality of one-to-one relationships between each particular student assignment in said table, both current and completed, and a file name of a specific web page template for said student assignment also stored in said data storage and retrieval means.

3. The study aid and practice aid apparatus of claim 1, wherein the said data storage and retrieval means contains subject-specific study and practice material and subject-specific reference material.

4. The study aid and practice aid apparatus of claim 3, wherein the said subject-specific study and practice material and subject-specific reference material comprises:
(a) a dictionary containing a row entry as a primary key for each vocabulary word, and further containing column entries for a definition of said primary key word, the said words grammatical part of speech, an example of correct usage of said word, a possibly null file name of an illustrative graphic image for said word, and a possibly null translation of the said primary key word into another language;
(b) a glossary of grammar containing a row entry as a primary key for each language grammar term, and further containing column entries for a definition of the said grammar term primary key and an example of correct grammatical usage;
(c) stories organized into a plurality of increasingly difficult reading levels; and,
(d) educational games and puzzles organized into a plurality of increasingly difficult levels.

5. The study aid and practice aid apparatus of claim 1, wherein the said data storage and retrieval means includes a file directory containing a plurality of binary encoded sound files.

6. The study aid and practice aid apparatus of claim 1, wherein the said data storage and retrieval means includes a file directory containing a plurality of binary encoded graphics files.

7. The study aid and practice aid apparatus of claim 1, wherein the said data storage and retrieval means includes a file directory containing a plurality of text-based templates for electronic student workbook web pages, where each said template is comprised of HTML code, style sheet code, server-side script language code, and client-side script language code.

8. The study aid and practice aid apparatus of claim 1, wherein the said data storage and retrieval means includes a file directory containing a plurality of reusable client-side web page scripts.

9. An improved method for displaying an integrated electronic student desktop for self-study and practice, comprising the step of providing a web page that operatively partitions a client-side graphical visual display means into a plurality of named independent display areas, and further providing a menu display in one of the said displays area, which menu display comprises a list of study aid and practice aid activities available to a user.

10. The improved method for displaying an electronic student desktop of claim 9, further providing a menu display comprising at least the entries:
(a) a selection for an integrated electronic multi-lingual language dictionary,
(b) a selection for an integrated electronic glossary of language grammar,
(c) a selection for displaying a link to the currently assigned study aid and practice aid web page for the current user, and further comprising a list of links to study aid and practice aid web pages which web pages have been declared by the surrent user as having been completed,
(d) a selection for an integrated library of web page based stories,
(e) a selection for an integrated library of web page based educational games, and
(f) a selection for displaying a link to a programmatic method that will assign the next electronic student workbook web page to the current user.

11. The improved method for displaying an electronic student desktop of claim 9, further providing a web page display in a second display area of the said displays area, which web page display comprises the first web page displayed as a result of a current user making a user menu selection from any of the said user menu items.

12. An improved method for generating, displaying and using an interactive electronic student workbook for self-study and practice of language literacy skills, comprising the steps of:
(a) providing a many-to-many correspondence table that cross references a primary key for a particular assignment for a particular student to a unique file name of a particular web page template containing HTML code, style sheet code, server-side scripts, and client-side scripts,
(b) providing a list of primary database keys for assignments associated with a particular student, one of which keys is a key to the current workbook assignment for that student and the other keys being keys to workbook assignments completed by that student,
(c) providing a retrieval of a unique file name of a particular workbook web page template associated with a user-chosen assignment primary key,
(d) providing a library of reusable workbook web page components, including text fragments, images, sounds, client-side scripts, dictionary entries, grammar entries, stories, and educational games,
(e) using the retrieved unique file name of a particular workbook web page template to retrieve said template from said data storage and retrieval means, and passing said template to said server-side script processing method,
(f) interpreting coded references contained in said workbook template from step (e) and using said references to retrieve reusable web page components from a data storage and retrieval means and assembling the said reusable web-page components into a workbook web page, and
(g) passing the said generated web page to a web page server method for delivery to the client-side browser.

13. The method of interpreting coded references and assembling web-page components into a workbook web page of step (f) of claim 12, further comprising the step of embedding a plurality of client-side scripts into said workbook page during the process of generating said workbook web page, whereby said client-side scripts can respond programmatically to client-side web page user input activity by trapping document object madel events and executing client-side script functions, where each client-side script function is programmatically associated with one or more specific document object model events.

14. The step of embedding a plurality of client-side scripts into a workbook web page of claim 13, wherein at least one of said client-side scripts programmatically responds to a plurality of different user inputs on a workbook web page by displaying a temporary avatar window, which avatar window is comprised of programmatically determined text and images and sounds for one-way communication to the current user.
